(19) United States
(12) Patent Application Publication
(10) Pub. No.: US 2025/0118932 A1
(43) Pub. Date: Apr. 10, 2025

(54) LOCKING DEVICE FOR A CHARGING SOCKET UNIT AND A CHARGING SOCKET UNIT

(71) Applicant: HELLA GMBH & CO. KGAA, Lippstadt (DE)

(72) Inventors: Jann Berhorst, Borchen (DE); Clemens Maßmann, Wadersloh (DE); Fabian Utermöhlen, Lippstadt (DE)

(21) Appl. No.: 18/904,457

(22) Filed: Oct. 2, 2024

(30) Foreign Application Priority Data
Oct. 9, 2023 (DE) 102023127429.5

(51) Int. Cl. H01R 13/639; B60L 53/16; E05B 81/06; E05B 81/16; E05B 81/30; E05B 81/34; E05B 83/28; H01R 13/447

(52) U.S. Cl. CPC H01R 13/6397; B60L 53/16; E05B 81/06; E05B 81/16; E05B 81/30; E05B 81/34; E05B 83/28; H01R 13/447

(57) ABSTRACT

The invention relates to a locking device for a charging socket unit. The locking device includes an electromotive actuator, a first locking means operable by means of the actuator, with a locking pin for locking a charging plug to a charging socket of the charging socket unit, and a second locking means operable by means of the actuator and configured to lock a socket cover of the charging socket unit.

### CROSS-REFERENCE TO RELATED APPLICATIONS

The present application claims the benefit of German Patent Application No. 10-2023-127-429.5, filed Oct. 9, 2023, the disclosure of which is incorporated by reference.

### FIELD OF THE INVENTION

The present invention relates to a locking device for a charging socket unit and to a charging socket unit for a charging station or an electric vehicle with a locking device according to the invention.

### BACKGROUND OF THE INVENTION

Standardized connector types and charging modes are known for the conductive charging and discharging of batteries in electric vehicles at charging stations, in particular from the international standard IEC 62196. One aspect concerns a mechanical locking of the charging plug at the charging socket as a safety measure during the charging process. In the case of the type 2 charging coupler used as the Europe-wide standard for electric vehicles, the charging plug inserted into the charging socket is locked by means of a locking pin. The locking pin is part of a locking device that drives a displacement of the locking pin to close and open the lock.

Charging sockets must also be protected against the weather and environmental influences, for which socket covers with spring-loaded cover flaps are known in the prior art. However, these usually do not provide sufficient tightness to reliably prevent the ingress of moisture or dust, particularly as they age. Furthermore, there is no protection against unauthorized opening and vandalism.

### SUMMARY OF THE INVENTION

The object of the present invention is to propose a locking device and an associated charging socket unit that allows both standardized locking of a charging plug and effective protection of the charging socket when not in use.

This object is achieved by means of a locking device for a charging socket unit, the locking device including an electromotive actuator, a first locking means, operable by means of the actuator, with a locking pin for locking a charging plug to a charging socket of the charging socket unit, and a second locking means operable by means of the actuator and designed to lock a socket cover of the charging socket unit.

The invention is based on the idea of designing the locking device with two locking means, both of which can be actuated by means of the same electromotive actuator and are designed to lock a charging plug and a socket cover. This creates a locking device with an increased range of functions, which is, however, compatible with the charging socket units commonly used in the prior art in terms of the installation dimensions and the installation position on the associated charging socket. The locking pin has a tapering end portion that is designed to engage in an associated receptacle on the periphery of the charging plug so that it can be secured against being pulled out of the charging socket unintentionally. The second locking means can be used to lock the socket cover when it is not in use, thus preventing unauthorized opening. Furthermore, the second locking means can be used to exert a force on the socket cover, preferably in such a manner that the socket cover comes into a media-tight abutment against a bracket of the charging socket unit.

In particular, the electromotive actuator has an output shaft, wherein the first locking means and/or the second locking means are received at least in component form on the drive shaft and are connected to it in a rotationally fixed manner. Thus, both locking means can preferably be actuated simultaneously by operating the actuator. In addition to an electric motor, the actuator includes a transmission connected upstream of the drive shaft, for example.

An advantageous embodiment of the locking device includes a first locking means having a drive arm with an elongated hole, wherein the drive arm is connected to the drive shaft of the actuator in a rotationally fixed manner and projects radially from the drive shaft, wherein the locking pin has a stud that engages in the elongated hole, and a holding frame for guiding the locking pin, in such a manner that a rotation of the drive shaft can be transmitted to a translation of the locking pin. A rotation of the drive shaft causes a pivoting movement of the drive arm, and the stud that is entrained in the elongated hole causes a displacement of the linearly guided locking pin. The angle of rotation of the drive shaft can be approximately 90°, for example, between the extreme locking positions of the locking pin.

An alternative embodiment includes a first locking means having a gear wheel that is connected to the drive shaft of the actuator in a rotationally fixed manner, wherein the locking pin is designed in portions as a rack in which the gear wheel engages, an a holding frame for guiding the locking pin, in such a manner that a rotation of the drive shaft can be transmitted to a translation of the locking pin.

The second locking means has in particular a hook that is connected to the drive shaft in a rotationally fixed manner and is designed to engage in an eyelet on the socket cover. A rotation of the drive shaft causes the hook to pivot, thus guiding it into or out of the eyelet.

Preferably, in the locking position, i.e., engaged with the eyelet, the hook exerts a force on the eyelet that presses the socket cover against an associated abutment surface of the charging socket unit, so that the seal against the ingress of water or dust is improved.

Furthermore, the invention relates to a charging socket unit for a charging station or an electric vehicle, including a charging socket, a socket cover for closing the charging socket, and a locking device according to any of the aforementioned embodiments, wherein the locking device is arranged in such a manner that a charging plug can be locked to the charging socket by means of the operation of the first locking means, and that the socket cover can be locked by means of the operation of the second locking means. The locking device is arranged in particular above the charging socket, and an opening for the locking pin is formed on the housing of the charging socket in such a manner that the locking pin can be guided through into a receptacle on a charging plug to be locked.

The charging socket unit according to the invention can, in principle, be configured for use in different types of electric vehicles, in particular for passenger vehicles, trucks or construction machines.

In another embodiment of the charging socket unit, the socket cover includes a cover flap with an eyelet on the inside, wherein the second locking means has a hook, wherein the hook is rotatable or pivotable by means of the drive shaft of the locking device between a locking position, in which the hook engages in the eyelet, and a release position, in which the hook does not form a connection with the eyelet.

In particular, the charging socket of the charging socket unit according to the invention is designed as a type 2 socket according to the IEC 62196-2 standard.

These and other features and advantages of the present invention will become apparent from the following description of the invention. Before the embodiments of the invention are explained in detail, it is to be understood that the invention is not limited to the details of operation set forth in the following description. The invention may be implemented in various other embodiments and of being practiced or being carried out in alternative ways not expressly disclosed herein. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

Further measures to improve the invention are set forth below, together with the description of exemplary embodiments of the invention based on the figures. In the figures:

FIGS. 1a and 1b show a locking device in the release and locking position;

FIGS. 2a and 2b show further views of FIG. 1b;

FIGS. 3a and 3b show an electromotive actuator;

FIG. 4 shows a first embodiment of a locking pin;

FIG. 5 shows a holding frame for the locking pin of FIG. 4;

FIGS. 6a and 6b show a first embodiment of the first locking means in the release and locking position;

FIG. 7 shows a second embodiment of a locking pin;

FIG. 8 shows a second embodiment of the first locking means; and

FIGS. 9a, 9b, 10a, 10b, 11a, and 11b show views of a charging socket unit with the socket cover locked and open.

### DETAILED DESCRIPTION OF THE CURRENT EMBODIMENTS

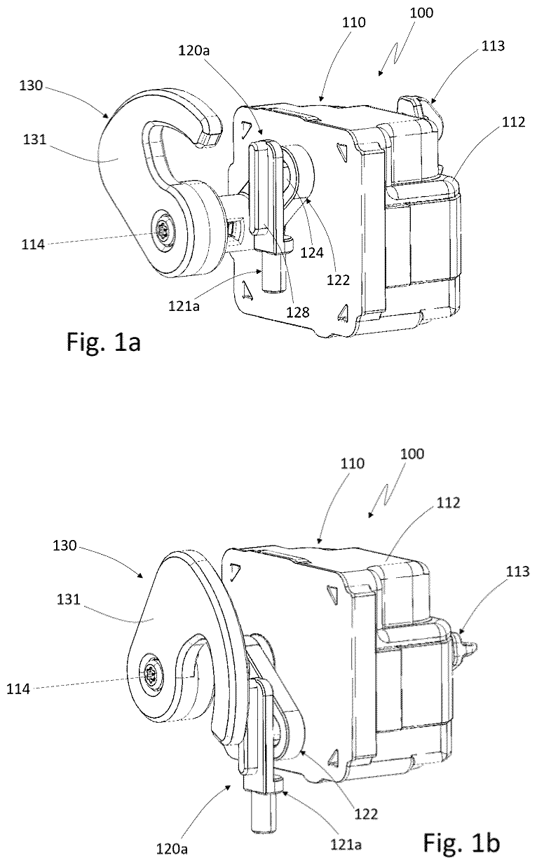

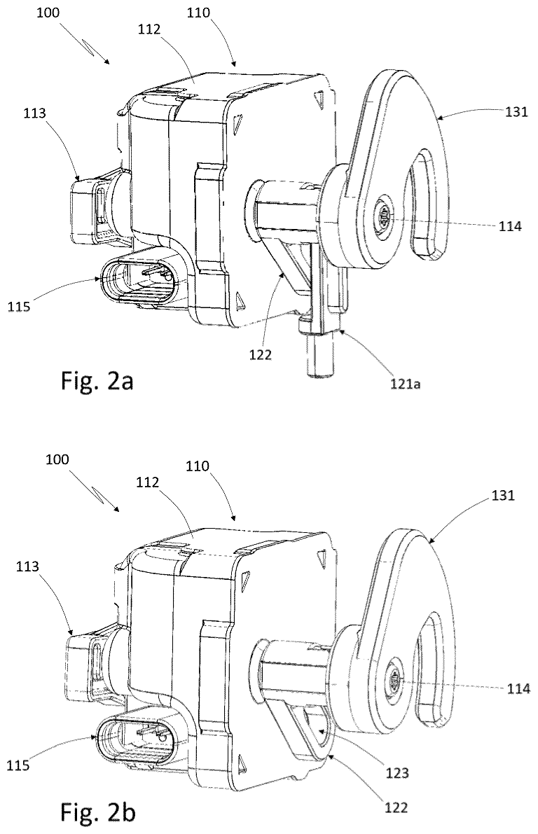

FIGS. 1a-2b show perspective views of an embodiment of the locking device 100 according to the invention, wherein, for the sake of clarity, the holding frame for guiding the locking pin 121a is not shown in each case. The locking device 100 comprises the electromotive actuator 110, the first locking means 120a, which can be operated by means of the actuator 110, with the locking pin 121a for locking a charging plug, as well as the second locking means 130, which can be actuated by means of the actuator 110, for locking a socket cover. FIG. 1a shows the two locking means 120a, 130 in the release position, the other figures show the locking position.

The actuator 110 has an output shaft that is not visible here and that can rotate about the axis of rotation 114, wherein the first locking means 120a and the second locking means 130 are received in component form on the drive shaft and are non-rotatably connected thereto. The electromotive components of the actuator 110 are housed in its housing 112 and are supplied and/or controlled via the contact socket 115.

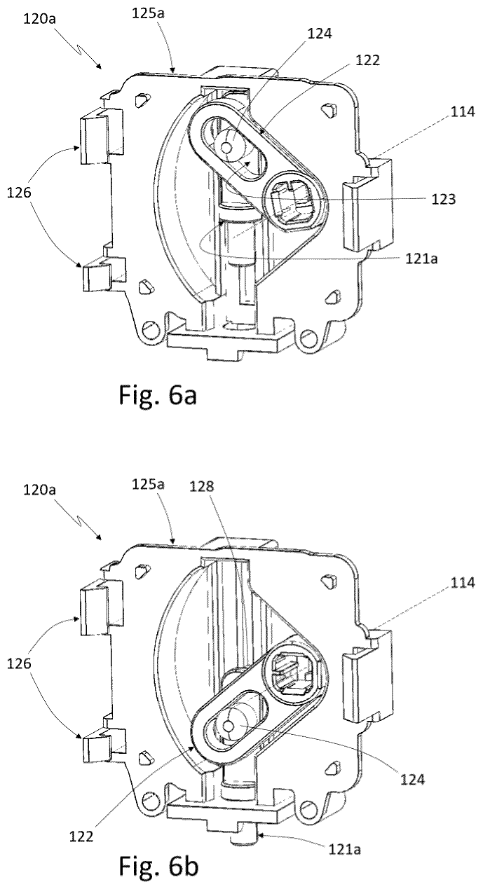

The first locking means 120a has the drive arm 122 with the elongated hole 123, wherein the drive arm 122 is connected in a rotationally fixed manner to the drive shaft of the actuator 110 and projects radially from the latter, wherein the locking pin 121a has the stud 124, which engages in the elongated hole 123. The elongated hole is particularly visible in FIG. 2b, in which the locking pin is not shown for this purpose. In conjunction with the holding frame for guiding the locking pin 121a, which is not shown in the figures (see FIG. 5), a rotation of the drive shaft about the axis of rotation 114 can be transmitted to a translation of the locking pin 121a, i.e., in a linear up and down movement between the extreme positions shown in the figures. The tapered end portion of the locking pin 121a is used to engage a matching receptacle on a charging plug to be locked.

The second locking means (130) has a hook (131) that is connected to the drive shaft in a rotationally fixed manner and is designed to engage in an eyelet on the socket cover. By means of the actuator 110, both locking means 120a, 130 can be simultaneously actuated and are each jointly in the respective release or locking position.

The locking device 100 also includes an emergency release mechanism with the emergency release lever 113 protruding from the rear of the housing 112 for manually turning the drive shaft to lock or unlock the two locking means 120a, 130 in the event of a failure of the electromotive actuator 110.

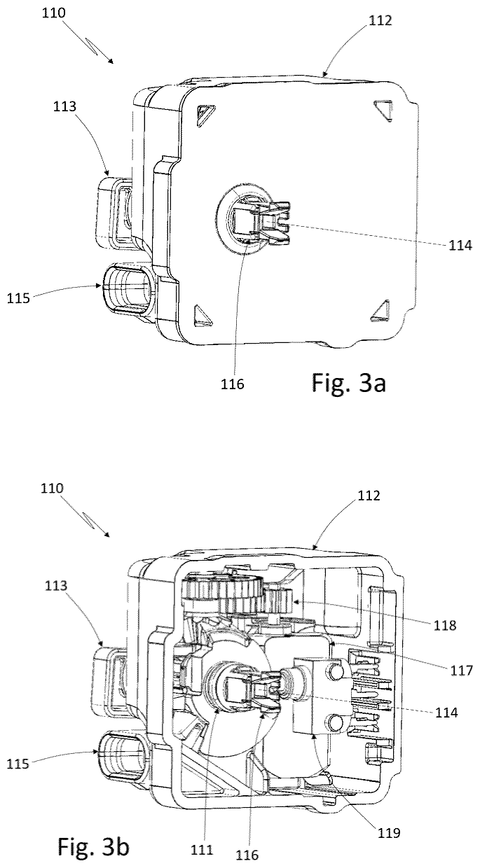

FIG. 3a and FIG. 3b show the 110 electromotive actuator of a locking device according to the invention, wherein in FIG. 3b the front cover of the housing 112 is removed so that the electromotive components inside are visible. The actuator 110 includes the electric motor 117, which drives the drive shaft 111 via the intermediate toothed gear drive 118. The receiving piece 116 is arranged on the drive shaft 111, via which the rotationally fixed connection to the locking means can be realized. The pressure sensor 119 can be used to detect pressure on the socket cover, causing a control command to be sent to the electric motor to unlock the locking means. Such a pressure-controlled opening of the charging socket unit can be activated, for example, during certain operating hours of an associated charging station so that users can start a charging process by pressing it manually.

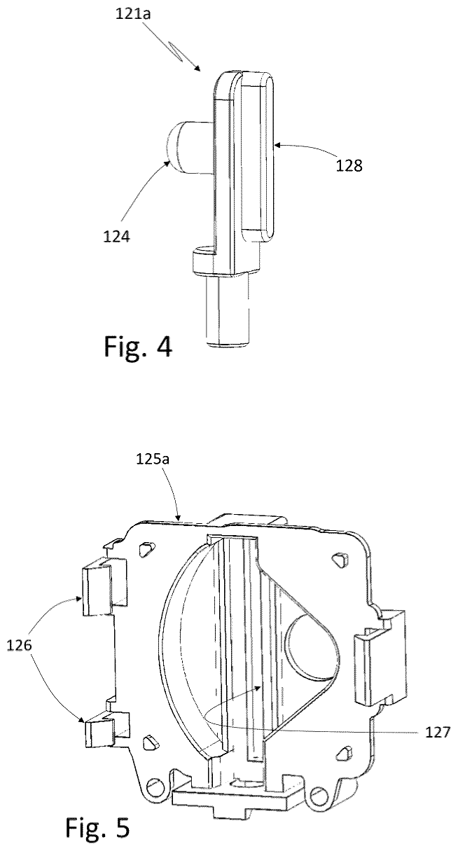

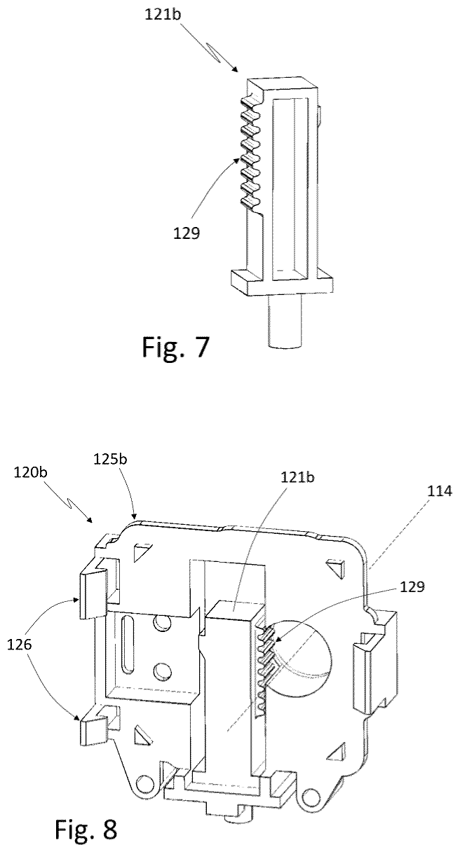

FIG. 4 shows a first embodiment of the locking pin 121a according to the embodiment of FIGS. 1a-2b, and FIG. 5 shows the associated holding frame 125a, which is not shown in the aforementioned figures for the sake of clarity. FIGS. 6a and 6b show all components of the first locking means 120a in a rear view.

The locking pin 121a comprises the stud 124 for engagement in the elongated hole 124 on the drive arm 122, and the spring 128 for insertion in the guide groove 127 of the holding frame 125a. The holding frame 125a provides the drive arm 122 with space for a pivoting range of approximately 90°, wherein the pivoting of the drive arm 122 is achieved by means of a rotation of the (not shown) rotationally fixed drive shaft of the actuator about the axis of rotation 114. The holding frame 125a includes the latching arms 126 for connection to the housing of the actuator.

FIG. 6a shows the locking pin 121a in the release position, in which it is fully displaced into the holding frame 125a, and FIG. 6b shows the locking position, in which the tapering end portion of the locking pin 121a projects from the underside of the holding frame 125a and can thus be engaged with a matching receptacle on a charging plug.

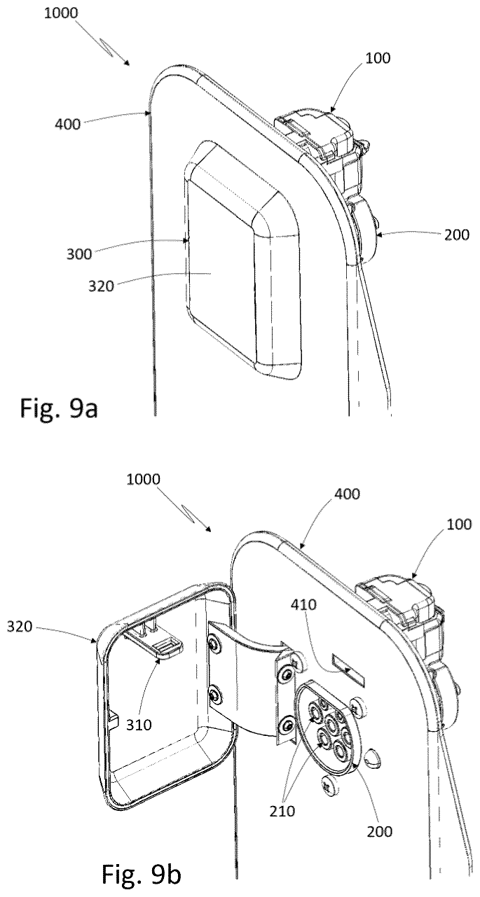

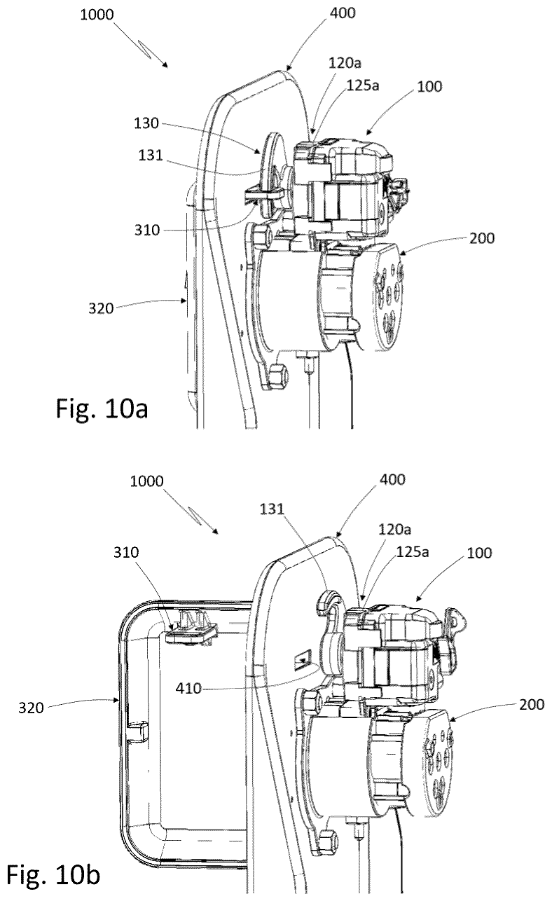

FIG. 7 shows a second embodiment of the locking pin 121b, which is designed in portions as a rack 129. FIG. 8 shows the locking pin 121b with the associated holding frame 125b as components of a second embodiment of the first locking means 120b. An associated gear wheel is not shown, but it is connected to the drive shaft of the actuator 110 in a manner that prevents relative rotation and can therefore rotate about the axis of rotation 114. The rotation of the drive shaft can thus be transmitted to the translation of the locking pin 121b via the engagement of the gear wheel with the rack 129.

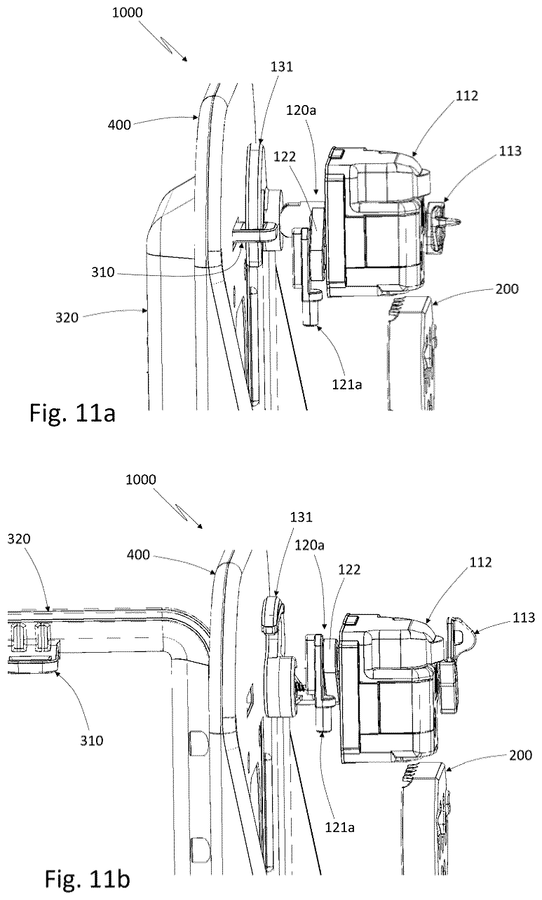

FIGS. 9a-10b show perspective views of an embodiment of the charging socket unit 1000 according to the invention, comprising the charging socket 200, the socket cover 300 and the locking device 100 according to the invention. The charging socket 200 is designed as a type 2 socket according to the IEC 62196-2 standard. The charging socket unit 1000 is shown here as an example of a charging station on the bracket 400. Furthermore, on-board integration would be possible.

The locking device 100 is arranged in such a manner that a charging plug can be locked to the charging socket 200 by means of the first locking means 120a, and that the socket cover 300 can be locked by means of the second locking means 130.

The socket cover 300 includes the cover flap 320 with the eyelet 310 on the inside, wherein the second locking means 130 has the associated hook 131. The hook 131 is moved by means of the drive shaft of the locking device 100 between the locking position shown in FIGS. 9a and 10a, in which the hook 131 engages in the eyelet 310 and the release position shown in FIGS. 9b and 10b, in which the hook 131 does not form a connection with the eyelet 310, rotatably or pivotally.

In the closed position, the socket cover 300 protectively covers the charging contacts 210 and the eyelet 310 passes through the slot 410 in the bracket 400 into the pivoting range of the hook 131. In the locking position, the hook 131 exerts a force on the cover flap via the eyelet 310, holding it in a media-tight manner against the front of the bracket 400.

FIGS. 11a and 11b show sections of the same embodiment of the charging socket unit 1000, wherein the holding frame of the first locking means 120a and the charging socket 200 are not shown except for the rear cover, so that the position of the locking pin 121a relative to the charging socket 200 in the locking position (FIG. 11a) and in the release position (FIG. 11b). It can be seen from this that the tapered end portion of the locking pin 121a penetrates into the charging socket 200 through the circumference of the housing in order to lock a charging plug.

The invention is not limited to the preferred embodiments set forth above. Rather, a number of variants are conceivable, which also make use of the solution presented here in fundamentally different designs. Any features and/or advantages, including design details and spatial arrangements, that are apparent from the claims, the description or the drawings may, either independently or in various combinations, be essential to the invention.

### LIST OF REFERENCE NUMERALS

1000 charging socket unit
100 locking device
110 actuator
111 drive shaft
112 housing
113 emergency release cover
114 axis of rotation
115 contact socket
116 receiving piece
117 electric motor
118 toothed gear drive
119 pressure sensor
120a, 120b first locking means
121a, 121b locking pin
122 drive arm
123 elongated hole
124 stud
125a, 125b holding frame
126 latching arm
127 guide slot
128 spring
129 rack
130 second locking means
131 hook
200 charging socket
210 charging contact
300 socket cover
310 eyelet
320 cover flap
400 bracket
410 slot

The above description is that of current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A locking device for a charging socket unit, the locking device comprising:
an electromotive actuator;
a first locking means, operatively coupled to the actuator, with a locking pin for locking a charging plug to a charging socket of the charging socket unit; and
a second locking means, operatively coupled to the actuator, the second locking means being configured to lock a socket cover of the charging socket unit.

2. The locking device of claim 1, wherein the electromotive actuator includes a drive shaft, wherein the first locking means or the second locking means are received on the drive shaft or are connected to the drive shaft in a rotationally fixed manner.

3. The locking device of claim 2, wherein the first locking means includes:
a drive arm with an elongated hole, the drive arm being connected to the drive shaft of the actuator in a rotationally fixed manner and projecting radially from the drive shaft, the locking pin including a stud that engages the elongated hole; and
a holding frame for guiding the locking pin, such that a rotation of the drive shaft causes a translation of the locking pin.

4. The locking device of claim 2, wherein the first locking means includes:
a gear wheel that is connected to the drive shaft of the electromotive actuator in a rotationally fixed manner, wherein the locking pin is configured as a rack in which the gear wheel engages; and
a holding frame for guiding the locking pin, such that a rotation of the drive shaft causes a translation of the locking pin.

5. The locking device of claim 2, wherein the second locking means includes a hook that is connected to the drive shaft in a rotationally fixed manner and is configured to engage an eyelet on the socket cover of the charging socket unit.

6. A charging socket unit for a charging station or an electric vehicle, comprising:
a charging socket;
a socket cover for closing the charging socket; and
the locking device of claim 1, wherein a charging plug can be locked to the charging socket by operation of the first locking means, and wherein the socket cover can be locked by operation of the second locking means.

7. The charging socket unit of claim 6, wherein the socket cover comprises a cover flap having an eyelet, wherein the second locking means has a hook, wherein the hook is rotatable by means of the drive shaft of the locking device between a locking position, in which the hook engages the eyelet, and a release position, in which the hook does not engage the eyelet.

8. The charging socket unit of claim 6, wherein the charging socket is configured as a type 2 socket according to IEC 62196-2.
